(19) United States
(12) Patent Application Publication
(10) Pub. No.: US 2009/0020735 A1
(43) Pub. Date: Jan. 22, 2009

(54) FLAME RETARDANT COMPOSITION EMPLOYING OIL SAND TAILINGS

(75) Inventor: Xiaoyi Gong, Ponca City, OK (US)

Correspondence Address: ConocoPhillips Company - IP Services Group;Attention: DOCKETING, 600 N. Dairy Ashford, Bldg. MA-1135, Houston, TX, 77079, US

(73) Assignee: CONOCOPHILLIPS COMPANY, Houston, TX (US)

(21) Appl. No.: 11/778,178

(22) Filed: Jul. 16, 2007

(51) Int. Cl. C09K 21/06

(52) U.S. Cl. 252/604; 252/609

(57) ABSTRACT

A flame retardant composition comprising at least one polymeric material and at least one inorganic filler, where at least a portion of the filler comprises particles derived from oil sand tailings. Such flame retardant composition can be employed in the manufacture and use of flame retardant plastics, fibers, and/or paints.

### BACKGROUND OF THE INVENTION

1. Field of the Invention

The present invention relates generally to the use of oil sand tailings (OST) as inorganic fillers in filled polymer composites. More specifically, the present invention relates to the use of oil sand tailings as a filler in polymers to be used in flame retardant plastics, fibers, and/or paints.

2. Description of the Prior Art

In many different industries, such as construction, furniture, transportation, and electronics, plastics made from polymers are employed as materials in various capacities. Additionally, fibers made from polymers are frequently employed in the textiles industry. Furthermore, paints often employ polymeric components. In many of these applications employing polymers, it is desirable for the plastics, fibers, and/or paints to be flame retardant for improved safety.

One past solution to this need combines inorganic fillers with a polymer to produce a composite having improved flame retardant characteristics. Conventionally, clay particles have been employed as inorganic fillers and combined with polymers to produce such flame retardant composites. Ordinary clays however, such as kaolin and bentonite, do not bond well to the polymers used in known methods due, presumably, to the fact that the fillers are inorganic whereas the polymers are organic. Such poor bonding can cause the clay-filled composites to be vulnerable to moisture and to have poor thermal stability, as well as low resistance to oxidation. Previous attempts to solve the problem of poor bonding between the filler and the polymer have involved treating the surface of the filler particles with an organic coating, such as, for example, stearic acid. However, such surface treatment, while improving other properties, tends to have an adverse effect on the flame retardant characteristics of the resulting composite. Accordingly, there is a need for improved fillers for use with polymers in forming flame retardant composites.

As with most mining operations, the mining of bitumen from oil sands creates tailings. Oil sand tailings are a particulate waste stream generally comprising hydrocarbon losses and a mixture of mineral particles and water. The mineral particles can comprise silica and/or silicates and can potentially comprise a thin organic coating left over from the bitumen extraction process. These particles can vary widely in size, ranging from less than 10 mm up to about 2 cm.

Conventionally, oil sand tailings are disposed of using tailings ponds. After the extraction process, the tailings stream can be pumped and discharged into a tailings pond where the coarse mineral particles almost immediately settle onto an accreting beach. However, the fine mineral particles may become entrained in the surface water layer where they remain suspended for an induction period, which can vary from several hours up to about three months. After the induction period, the fine particles settle into a fine tailings layer. Given the length of time it takes for these fine tails to settle in the tailings ponds, they consequently have the greatest adverse impact on the surrounding environment.

To lessen their effect on the environment, some attempts have been made to employ oil sand tailings in various types of manufacturing. However, these attempts to date have proven unsuccessful. For example, efforts have been made to employ fine tails of oil sand tailings in the manufacture of bricks. However, this was unsuccessful due to the black cores left by the tailings during the firing process. These black cores were most likely due to the residual bitumen on the fine tails.

Accordingly, in addition to the need for improved fillers in flame retardant composites mentioned above, there is also a need for improved methods of disposal or use of fine tailings resulting from the extraction of bitumen from oil sands.

### SUMMARY OF THE INVENTION

In one embodiment of the present invention, there is provided a flame retardant composition comprising at least one polymeric material and at least one filler. At least a portion of the filler comprises a plurality of particles from oil sand tailings.

In another embodiment of the present invention, there is provided a method for preparing a flame retardant composition. The method of this embodiment comprises: (a) blending a polymeric material and a filler to thereby form a mixture; and (b) heating at least a portion of the mixture, wherein at least a portion of the filler comprises a plurality of particles from oil sand tailings.

In yet another embodiment of the present invention, there is provided a method for preparing a flame retardant composition. The method of this embodiment comprises: (a) extracting a hydrocarbon-containing material from an oil sand deposit; (b) processing the hydrocarbon-containing material to thereby produce a separated bituminous material and oil sand tailings, wherein the oil sand tailings comprise a plurality of particles; and (c) combining at least a portion of the particles with at least one polymeric material to thereby form the flame retardant composition.

### BRIEF DESCRIPTION OF THE DRAWING FIGURES

A preferred embodiment of the present invention is described in detail below with reference to the attached drawing figures, wherein:

FIG. 1 is a schematic diagram of an extraction and processing system for obtaining bitumen from an oil sand deposit;

FIG. 2 is a view of an oil sand tailings (OST)-filled polyethylene composite, magnified 14,000 times;

FIG. 3 is a view of a kaolin-filled polyethylene composite, magnified 14,000 times;

FIG. 4 is a graph illustrating the percent weight change of an OST-filled polyethylene composite versus a kaolin-filled polyethylene composite after boiling each in water for 1 hour;

FIG. 5 is a view of an OST-filled nylon 6,6 composite, magnified 14,000 times;

FIG. 6 is a view of a kaolin-filled nylon 6,6 composite, magnified 14,000 times;

FIG. 7 is a microscopic view of an OST-filled acrylonitrile-butadiene-styrene (ABS) copolymer;

FIG. 8 is a microscopic view of a bentonite-filled ABS copolymer;

FIG. 9 is a view of an OST-filled polystyrene composite, magnified 14,000 times;

FIG. 10 is a view of a kaolin-filled polystyrene composite, magnified 14,000 times; and

FIG. 11 is a weight percent vs. temperature plot depicting the thermogravimetric analyses of an OST-filled epoxy in air, an OST-filled epoxy in nitrogen, a kaolin-filled epoxy in air, and a kaolin-filled epoxy in nitrogen, determined in accordance with the procedure described in Example 11.

### DETAILED DESCRIPTION

In accordance with one embodiment of the present invention, a flame retardant composition can be provided comprising at least one polymeric material and a plurality of particles of an inorganic filler, where at least a portion of the filler particles comprise particles derived from oil sand tailings (OST). The flame retardant compositions of the present invention can be employed in the manufacture and use of flame retardant plastics, fibers, and/or paints.

The filler particles of the present invention can comprise any flame retardant material, so long as at least a portion of that material is derived from oil sand tailings. As used herein, the term “inorganic filler” shall denote a filler material comprising at least one inorganic component, and can optionally also include one or more organic components. As used herein, the term “inorganic component” shall denote any compound not containing a hydrocarbon group. As used herein, the terms “oil sand tailings” and “OST” shall denote any material that has been at least partially separated from a bituminous material and which comprises at least one inorganic component. As used herein, the term “bituminous material” shall denote any material predominately containing bitumen. As used herein, the term “bitumen” shall denote any hydrocarbon-containing material having an API gravity of less than about 10°. As used herein, the terms “predominately,” “primarily,” and “majority” shall mean more than fifty percent.

In one embodiment of the present invention, the above-mentioned particles from oil sand tailings can be obtained from the tailings produced during a bitumen extraction process. Any process or processes for extracting bitumen from an oil sand deposit that result in the production of oil sand tailings can be employed in the present invention. Typically, bitumen extraction processes employ at least two steps: 1) mining to obtain oil sand ore and 2) removing bitumen from the ore.

The mining process of the present invention can be any mining process known in the art to obtain oil sand ore. As used herein, the term “oil sand ore” shall denote any material excavated from an oil sand deposit that comprises bitumen and at least one inorganic component. For example, the mining process of the present invention can comprise surface mining techniques, which typically involve removing the overburden on top of the oil sand deposit and thereafter excavating oil sand ore. Examples of surface mining include, but are not limited to, strip mining and open pit mining.

The mining process of the present invention can also comprise in situ mining methods, such as, for example, steam assisted gravity drainage (SAGD), cyclic steam stimulation (CSS), and vapor extraction processes (VAPEX). In SAGD, two horizontal wells can be drilled in the oil sand deposit. One of the wells is typically drilled near the bottom of the oil sand formation and the other well can be drilled about 5 meters above the lower wellbore. Subsequently, steam can be injected into the upper wellbore, which causes the bitumen to melt. This in turn allows the bitumen to flow into the lower well, where it can be pumped to the surface. VAPEX is similar to SAGD but, instead of steam, hydrocarbon solvents can be injected into the upper well to dilute the bitumen and allow it to flow into the lower well. CSS can involve repeated cycles of injecting steam into a wellbore penetrating an oil sand deposit formation, allowing the steam to heat the formation, and subsequently pumping heated bitumen to the surface via the wellbore. In addition to these and other in situ methods, the mining process of the present invention can also employ any underground mining techniques known in the art.

Once the oil sand ore has been excavated, it is typically processed in a treatment facility to separate the bitumen from unwanted materials, such as, for example, sand, silt, and/or clay. Any method known in the art for removing at least a portion of the bitumen from the oil sand ore can be employed in the present invention. In one embodiment of the present invention, the bitumen extraction process can include a hot water process. A hot water process, such as the Clark hot water process, typically involves treating the oil sand ore in a digester or tumbler with hot water and steam. A process aid, such as, for example, sodium hydroxide, can also be added to the digester or tumbler to aid in removing the bitumen from the ore. The resulting pulp can be passed to a separation vessel where the sand and other inorganic materials can settle to the bottom portion of the vessel, where they can then be withdrawn as tailings and employed in the present invention. The dissolved bitumen can float upwards to the upper portion of the vessel, forming a coherent mass known as froth, which can be recovered by skimming techniques in the separation vessel. A third aqueous stream in between the froth and tailings (typically called middlings) can be withdrawn separately and sent to a scavenging unit which can further recover suspended bitumen employing similar processes. Many variations of this procedure are known in the art, any of which can be used in the present invention.

Another bitumen removal technique involves the use of hydrocyclones or cyclone separators, where centrifugal action is used to separate the low specific gravity materials (e.g., bitumen and water) from the higher specific gravity materials (e.g., sand and clay). In this technique, crushed oil sand ore can be fed to a slurry mixing tank to form a slurry of the crushed oil sand ore and water. The resulting slurry can be fed into one or more hydrocyclones, where the slurry can be subjected to centrifugal force. The resulting product from the hydrocyclone is typically a bitumen froth ready for further treatment in a treatment facility and a tailings byproduct. The tailings can be collected from the hydrocyclone and employed in the present invention.

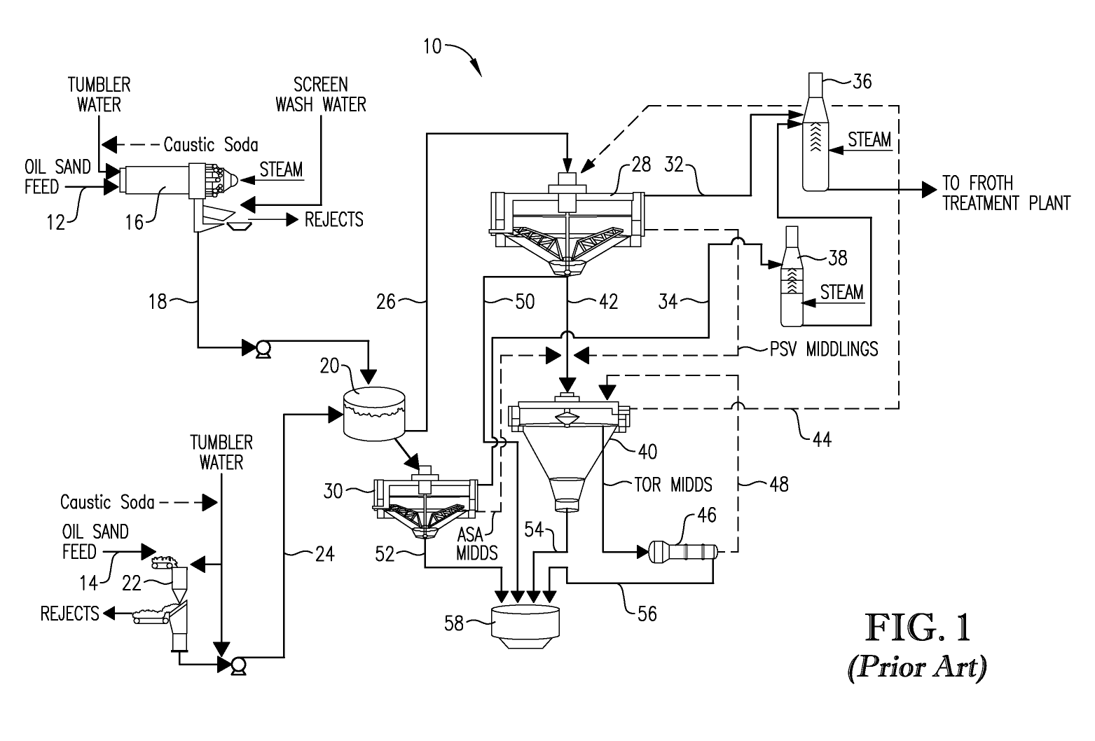

An example of a commercial bitumen extraction process is illustrated in FIG. 1. In FIG. 1, two oil sand feeds can enter extraction process 10 via lines 12 and 14 respectively. The first oil sand feed can initially enter tumbler zone 16 via line 12, where it can be mixed with steam, hot water, and caustic soda (sodium hydroxide) to form a first slurry. The first slurry can then be passed through a screen to reject large material, such as, for example, rocks, sticks, and lumps of clay. The first slurry can then be transported via line 18 to superpot 20. The second oil sand feed can initially be introduced into separator 22 via line 14 in order to remove large material. The separated oil sand ore can then be mixed with water and caustic soda to form a second slurry. The second slurry can be transported via line 24 to superpot 20 where the first and second slurries can be blended together.

Once the two slurries have been blended in superpot 20, a portion of the resulting blended slurry can be transported via line 26 to primary separation vessel 28. Primary separation vessel 28 is a deep cone vessel designed to recover most of the bitumen from the slurry. During primary separation, most of the bitumen floats to the top of primary separation vessel 28 in the form of froth while the majority of the sand sinks to the bottom, as discussed above. In the process depicted in FIG. 1, a portion of the blended slurry can also be sent to an auxiliary settling area 30, which is simply a smaller version of primary separation vessel 28. Froth from both primary separation vessel 28 and auxiliary settling area 30 can be sent to primary deaerator 36 and secondary deaerator 38 via lines 32 and 34 respectively. After deaeration, the deaerated froth can be sent to a froth treatment plant to upgrade the bitumen to synthetic crude oil.

A portion of the tailings from primary separation vessel 28 can be routed to tailings oil recovery vessel 40 via line 42 for further bitumen separation. Additionally, the middlings from both primary separation vessel 28 and auxiliary settling area 30 can optionally be routed to tailings oil recovery vessel 40, where the middlings can undergo further bitumen separation.

After separation in tailings oil recovery vessel 40, the resulting froth can optionally be routed to primary separation vessel 28 via line 44 for further treatment to yield higher quality bitumen. Additionally, middlings from tailings oil recovery vessel 40 can be routed to cycloseparator 46 for further bitumen separation. After treatment in cycloseparator 46, the resultant froth can optionally be routed back to tailings oil recovery vessel 40 via line 48 for further bitumen separation.

Oil sand tailings from each of primary separation vessel 28, auxiliary settling area 30, tailings oil recovery vessel 40, and cycloseparator 46 can be routed to distributor 58 via lines 50, 52, 54, and 56 respectively. The tailings collected in distributor 58 can then be employed in the present invention.

In one embodiment of the present invention, the OST particles produced as a byproduct in any of the above-described extraction processes can comprise any inorganic material typically found in oil sand deposits. In one embodiment, the OST particles can comprise clay, one or more silicates, titanium, potassium, iron, and/or sulfur. The silicates of the OST particles can comprise aluminum silicate and/or silicon dioxide. Additionally, as will be discussed in greater detail below, the OST particles can comprise residual hydrocarbonaceous material.

The OST particles produced as a byproduct of the bitumen extraction processes discussed above can have a highly varied particle size. The OST particles can range in size from about 10 nm to about 2 cm. In one embodiment, the OST can include a fine tails fraction, which can have particles ranging in size from about 1 to about 50 micrometers (μm). Additionally, the fine tails fraction can have a median particle size in the range of from about 1 to about 20 μm, in the range of from about 3 to about 15 μm, or in the range of from 5 to 9 μm. Furthermore, at least 90 percent of the fine tails fraction can have a particle size of less than about 25 μm, less than about 20 μm, or less than 15 μm. In another embodiment, at least 50 percent of the fine tails fraction can have a particle size of less than about 14 μm, less than about 12 μm, or less than 10 μm. Additionally, at least 10 percent of the fine tails fraction can have a particle size of less than about 9 μm, less than about 7 μm, or less than 5 μm. In one embodiment of the present invention, the fine tails fraction of the OST particles can have a surface area in the range of from about 1 to about 40 m²/g, in the range of from about 2 to about 30 m²/g, or in the range of from 3 to 20 m²/g.

In one embodiment, the OST particles can be reduced in size prior to being combined with the polymeric material as discussed below. Any method known in the art for producing finely divided particles can be employed in the present invention. Furthermore, the particle size of the OST particles employed can vary depending on the end use of the filled polymer composite. It will be understood by one skilled in the art that if the end use of the polymer composite will be plastics or films, the filler can have a larger median particle size than if the end use of the polymer composite will be for fiber. Accordingly, the particle size of the OST particles employed in the present invention can be selected and/or reduced according to the desired use of the resulting composite.

In another embodiment of the present invention, at least a portion of the OST particles to be employed as filler material can be at least partially coated with a hydrocarbonaceous material. In one embodiment, the OST particles can comprise a hydrocarbonaceous material in an amount of at least about 0.1 weight percent, at least about 0.5 weight percent, or at least 1.0 weight percent based on the combined total weight of the particles and the hydrocarbonaceous material. Additionally, the hydrocarbonaceous coating can have an average thickness on said particles of at least about 0.5 nm, at least about 1 nm, or at least 2 nm.

In one embodiment, the hydrocarbonaceous material can comprise hydrocarbon-containing molecules having an average number of carbon atoms of at least about 50, at least about 75, or at least about 100. In another embodiment, the hydrocarbonaceous material can comprise bitumen. As mentioned above, bitumen is defined as any hydrocarbon-containing material having an API gravity of less than about 10°. As used herein, the term “API gravity” is defined as the specific gravity scale developed by the American Petroleum Institute for measuring the relative density of various petroleum liquids. API gravity of a hydrocarbon is determined according to the following formula:

API gravity=(141.5/SG at 60° F.)−131.5

where SG is the specific gravity of the hydrocarbon at 60° F. Additionally, API gravity can be determined according to ASTM test method D1298. In one embodiment, the bitumen of the present invention can further have an API gravity of less than about 9°, or less than 8°.

As mentioned above, at least a portion of the particles of an inorganic filler for use in combination with a polymeric material to form a flame retardant composition can come from OST particles. In one embodiment of the present invention, the inorganic filler can comprise OST particles in an amount of at least about 50 weight percent, at least about 75 weight percent, or at least 95 weight percent based on the entire weight of the filler. In one embodiment, substantially all of the filler can be derived from OST particles. Additionally, at least about 50 weight percent of the OST particles employed in the filler can be derived from the above-described fine tails fraction of OST based on the total weight of OST particles employed. In another embodiment, at least about 75 weight percent, at least about 85 weight percent, at least about 95 weight percent, or at least 99 weight percent of the OST particles employed in the filler can be derived from the fine tails fraction of OST based on the total weight of OST particles employed.

In one embodiment, the balance of the inorganic filler not provided for by OST particles can comprise one or more other types of flame retardant filler particles. Any flame retardant filler known in the art can be employed as a supplement filler in the present invention, provided that such a supplemental flame retardant does not materially reduce the flame retardant effectiveness of the composite or detract from its thermal stability or moisture resistance. Suitable flame retardant filler particles for supplemental use in the present invention include, but are not limited to, hydrated inorganic fillers, such as, for example, hydrated alkaline earth carbonates (e.g., calcium carbonate or magnesium carbonate), hydrated mixed-metal carbonates (e.g., calcium magnesium carbonate), alkaline earth hydroxides (e.g., calcium hydroxide or magnesium hydroxide), aluminum trihydrate, and/or hydrated zinc borate. Other flame retardant inorganic fillers that can be used to supplement the OST particles can comprise conventional clay fillers, such as particles of kaolin clay and/or bentonite clay. Still other flame retardant fillers suitable for supplemental use in the present invention include aromatic bromine-containing flame retardants such as tetrabromobisphenol-A, pentabromobenzene, hexabromobenzene, pentabromotoluene, octabromobiphenyl, nonabromobiphenyl, decabromobiphenyl, tetrabromobisphenol-S; brominated aromatic carbonate oligomers; brominated epoxy oligomers; pentabromobenzyl polyacrylate; octabromotrimethylphenylindane; tris(tribromophenyl)cyanurate; and similar known organic bromine-containing flame retardants. Chlorine-containing flame retardants such as the chlorine-containing flame retardants available commercially under the names DECHLORANE and DECHLORANE PLUS, available from Occidental Chemical Corp., can also be employed as supplemental flame retardant fillers in the present invention.

As mentioned above, the inorganic filler of the present invention can be combined with a polymeric material to form a flame retardant composition. The polymeric material employed in the present invention can be any polymer or polymer precursor known in the art that is capable of being combined with a filler to form a filled polymer composite. The polymeric materials of the present invention can be thermoplastics, thermosets, and/or elastomers.

Polymers suitable for use as the polymeric material in the present invention include, but are not limited to, polyamides; polyesters and chlorinated polyesters; polyacrylates; polymethacrylates; polymers of ethylenically unsaturated monomers, including olefins such as polyethylene, polypropylene, polybutylene; copolymers of ethylene with higher olefins such as alpha olefins containing 4 to 10 carbon atoms or vinyl acetate, and the like; vinyls such as polyvinyl chloride; polyvinyl esters such as polyvinyl acetate; polystyrene; acrylic homopolymers and copolymers; phenolics; alkyds; amino resins; epoxy resins; polyurethanes; phenoxy resins; polysulfones; polycarbonates; polyethers; acetal resins; polyimides; polyoxyethylenes; polybutadiene; various rubbers and/or elastomers either natural or synthetic; and polymers based on copolymerization, grafting, or physical blending of various other monomers with the above-mentioned polymers. Also included are copolymers of any of the above. In one embodiment, the polymeric material employed in the present invention can be one or more polymers selected from the group consisting of polyethylene; polystyrene; polyvinyl chloride; nylon 6,6; acrylonitrile-butadiene-styrene (ABS) copolymer; epoxy resin; polybutadiene; polypropylene; polyurethane; and natural and/or synthetic rubber.

Preparation of the composite of the present invention can be performed by any method known in the art for preparing a filled polymer composite. In one embodiment, the filled polymer composite of the present invention can be prepared by dry blending the above-described inorganic filler with the selected polymeric material. If the polymeric material is in solid form, it can be ground to achieve any desired particle size distribution prior to being physically mixed with the filler. Additionally, as mentioned above, the filler can also be ground to achieve a desired particle size distribution. Moreover, the filler can optionally be dried using any drying method known in the art prior to blending the filler with the polymeric material. The polymeric material and filler can be blended for a length of time sufficient to achieve substantial uniformity throughout the blend. In one embodiment, the blending can be performed at ambient temperature.

After blending, the polymeric material and filler can be heated. In one embodiment, the blended polymeric material and filler can be placed in a suitable die, which can in turn be placed in a heating environment, such as, for example, an oven. The blended polymeric material and filler can be heated to a temperature of at least about the flow point of the selected polymeric material. In one embodiment, the blended polymeric material and filler can be heated to a temperature of at least about 70° C., at least about 85° C., or at least 100° C. Additionally, the blended polymeric material and filler can be heated for a time period of at least about 15 minutes, at least about 30 minutes, or at least 1 hour.

In one embodiment, pressure can be applied to the blended polymeric material and filler. After heating, the die can be removed from the heating environment and placed in a press, where pressure can be subsequently applied to the die. The amount of pressure applied to the blended polymeric material and filler can be at least about 300 p.s.i., at least about 600 p.s.i., or at least 900 p.s.i. The pressure can be applied to said blended polymeric material and filler for a period of time of at least about 15 minutes, at least about 45 minutes, or at least 90 minutes. After sufficient pressure has been applied to the blend, the resulting filled polymer composite can be removed from the die.

In another embodiment of the present invention, the filled polymer composite can be prepared by mixing the polymeric material and filler in a mixer while applying heat to the components. Mixing of the polymeric material and filler can be performed by any known methods in the art and with any conventional mixing device. In one embodiment, the mixer can be equipped with high shear mixing elements and a heating element for controlling the temperature at which the various components are being mixed. Furthermore, the mixing can be carried out in batch or continuous processes. After mixing, the resulting composition can be cooled to room temperature. Optionally, prior to cooling, the composite can be formed into various shapes (e.g., pellets) for convenient handling in subsequent operations. Additionally, the filled polymer composite can be extruded to form a desired shape employing conventional extruders and any method known in the art.

Regardless of the method employed to form the filled polymer composite, in one embodiment, the resulting composite can comprise inorganic filler in an amount of at least about 1 weight percent, in the range of from about 2 to about 90 weight percent, in the range of from about 5 to about 40 weight percent, or in the range of from 10 to 30 weight percent based on the entire weight of the composite. Furthermore, the resulting composite can have a weight ratio of inorganic filler to polymeric material in the range of from about 1:30 to about 9:1, in the range of from about 1:20 to about 1:2, or in the range of from 1:10 to 1:3.

In one embodiment, the composite can optionally contain a reinforcing material. Reinforcing material is typically employed in molded polymers to improve physical properties. Thus, any reinforcing material capable of improving a desired physical property of the resulting composite can be employed in the present invention. Suitable reinforcing agents include, but are not limited to, glass, carbon, aramid fibers, or mica. Reinforcing materials can be present in the composite in an amount in the range of from 0 to 30 weight percent based on the total weight of the composite. Any methods known in the art for incorporating a reinforcing material in a filled polymer composite can be employed in the present invention.

Additionally, the composite can contain other additives, such as, for example, antioxidants, ultra-violet light stabilizers, additives to improve the comparative tracking index (an electrical property), processing additives, and other additives used by those skilled in the art. Examples of ultra-violet light stabilizers include, but are not limited to, various substituted resorcinols, salicylates, benzotriazoles, benzophenones, and combinations thereof. Furthermore, the composite can also include lubricants and release agents, colorants (including dyes and pigments), fibrous and particulate fillers, nucleating agents and plasticizers to improve handling and processing properties of the composite and/or reduce its cost. Examples of lubricants and release agents include, but are not limited to, stearic acid, stearic alcohol, stearamides, and combinations thereof. Any methods known in the art for incorporating any one or any combination of the foregoing additives in a filled polymer composite can be employed in the present invention.

In one embodiment of the present invention, the resulting filled polymer composite can have a softening point of at least about 70° C., at least about 80° C., or at least 100° C. Furthermore, the resulting filled polymer composite can have a glass transition temperature (T_{g}) of at least about 80° C., at least about 90° C., or at least 110° C.

As mentioned above, the filled polymer composite can be employed as a flame retardant material. One measurement of flame retardancy is a material's Limiting Oxygen Index (LOI) value. This value represents the minimum oxygen concentration of an O₂/N₂ mixture required to sustain combustion of the material. LOI is determined by ASTM D 2863, and is calculated using the following formula:

LOI=(O₂/O₂+N₂)×100%

The higher the LOI value of a material, the more flame retardant that material is considered to be. In one embodiment, the filled polymer composite of the present invention can have an LOI value of at least about 27, at least about 29, or at least 31.

Another measure of a material's flame retardancy can be determined by its rate of burning. Determinations for rate of burning herein are measured according to ASTM D 635-03, titled “Standard Test Method for Rate of Burning and/or Extent and Time of Burning of Plastics in a Horizontal Position.” In one embodiment of the present invention, a composite prepared according to methods disclosed herein comprising polyethylene as the polymeric material can have a rate of burning of less than 2 inches per minute. In another embodiment, a composite prepared according to the methods disclosed herein comprising ABS as the polymeric material can have a rate of burning of less than 1.5 inches per minute.

As indicated above, the filled polymer composite of the present invention can have improved flame retardancy characteristics. Thus, the composite of the present invention can be used in any application in which flame retardant polymeric materials are needed or desired. For example, the composite of the present invention can be employed in plastics, fibers, and/or paints, and can be used in the construction and/or textiles industries.

In one embodiment of the present invention, the filled polymer composite can be used to make flame-retardant plastics. Plastic articles to be formed employing the filled polymer composite of the present invention can be formed employing any known technique in the art. Examples of such techniques include, but are not limited to, injection molding, compression molding, and extrusion.

In another embodiment of the present invention, the filled polymer composite can be used as a component in making flame retardant polymeric fiber. Any method known in the art for transforming a polymer into polymeric fibers can be employed in the present invention. For example, the filled polymer composite can be dry spun to form flame retardant polymeric fibers. Dry spinning can comprise the steps of dissolving the composite in a solvent and then pumping the solution through a spinneret having a plurality of holes. As the fibers exit the spinneret, air can be used to evaporate the solvent so that the fibers solidify and can be collected on a take-up wheel. Stretching of the fibers provides for orientation of the polymer chains along the fiber axis. Another example used in producing polymeric fibers is melt spinning. In melt spinning operations, the composite can be melted and pumped through a spinneret having numerous holes. The molten fibers can then be cooled, solidified, and collected on a take-up wheel.

In another embodiment, the filled polymer composite of the present invention can be used as a component in making flame retardant polymer-containing paints. Paints employing the filled polymer composite of the present invention can be formed employing any known method for making polymer-containing paints in the art. For example, the filled polymer composite of the present invention can be finely divided and dispersed in the continuous phase of a latex paint to improve the flame retardancy of the paint. Alternatively, OST particles can be dispersed directly into polymer-containing paints, such as latex paints, to form a flame-retardant paint.

### EXAMPLES

The following examples are intended to be illustrative of the present invention in order to teach one of ordinary skill in the art to make and use the invention and are not intended to limit the scope of the invention in any way.

In the Examples that follow, oil sand tailings (OST) particles were compared to conventional inorganic fillers in various types of polymers.

### Example 1

### Description of Oil Sand Tailings Filler

The oil sand tailings employed in the following examples were obtained from Syncrude Canada, Ltd. An example of Syncrude's extraction process is illustrated in FIG. 1. As can be seen by looking at FIG. 1, the oil sand tailings can exit the process from several different points and can be collected in the tailings boxes depicted in FIG. 1. The oil sand tailings employed in the examples were brownish in color and in the form of a slurry. Prior to use, the tailings were dried in an oven at 100° C. for a period of time sufficient to remove substantially the entire liquid component of the slurry. Subsequently, the dried tailings were ground to powder and analyzed. The results of the analyses are listed in Table 1 below. Surface area was determined using the BET (Brunauer, Emmett and Teller) method. Particle size was determined employing a MALVERN particle size analyzer. Morphology was determined by scanning electron microscope.

TABLE 1
Characteristics of OST Particles

| | Surface | Particle Size | |
|---|---|---|---|
| Chemistry | Area | Distribution | Morphology |
| Aluminum silicate | 5.0 m²/g | 10 percent: <2.6 μm | Smallest |
| with titanium, | | | structural |
| potassium, and iron | | 50 percent: <7.1 μm | units were |
| | | 90 percent: <11.5 μm | approximately |
| | | | 100 nm flakes. |

### Example 2

### Description of Conventional Inorganic Fillers

The conventional fillers employed in the following examples were commercially available clay fillers purchased from Sigma-Aldrich, Inc. The fillers employed were Kaolin and Bentonite, the characteristics of which are listed in Table 2 below.

TABLE 2
Characteristics of Conventional Inorganic Fillers

| | | Surface | Particle Size | |
|---|---|---|---|---|
| Filler | Chemistry | Area | Distribution | Morphology |
| Kaolin | Aluminum | 18 m²/g | 10 percent: <1.2 μm | Smallest |
| | Silicate | | 50 percent: <3.4 μm | structural units |
| | | | 90 percent: <7.1 μm | were |
| | | | | approximately |
| | | | | 100 nm flakes. |
| Bentonite | Aluminum | 37 m²/g | 10 percent: <2.6 μm | Smallest |
| | Silicate | | 50 percent: <5.2 μm | structural units |
| | | | 90 percent: <11.5 μm | were |
| | | | | approximately |
| | | | | 100 nm flakes. |

### Example 3

### Description of Polymers

In the following examples, five different polymers were employed: medium density polyethylene (MDPE); polystyrene; nylon 6,6; epoxy, and acrylonitrile-butadiene-styrene (ABS) copolymer. The MDPE, polystyrene, and nylon are all commercially available polymers, and each was purchased from Sigma-Aldrich, Inc. ABS is a general purpose amorphous resin and is commercially available under the name CYCOLAC T from General Electric, Fairfield, Conn., US. The epoxy and corresponding hardener employed in the following examples are commercially available under the name BUEHLER EPOXIDE and HARDENER from Buehler Ltd., Lake Bluff, Ill., US. Some of the characteristics of the polymers employed are listed in Table 3 below.

TABLE 3
Characteristics of Polymers

| | | Melting point | | |
|---|---|---|---|---|
| | Molecular | (mp)/Glass | | |
| | weight (MW)/Melt | Transition | | |
| Polymer | index (MI) | temperature (T_{g}) | Density | Form |
| MDPE | — | mp: 109~111° C. | 0.940 g/cm³ | Powder |
| Polystyrene | MW: 280,000 | T_{g}: 100° C. | 1.047 g/cm³ | Pellet |
| Nylon 6,6 | — | mp: 250~260° C. | 1.09 g/cm³ | Pellet |
| | | T_{g}: 45° C. | | |
| ABS | MI: 5.6 g/10 min. | — | 1.04 g/cm³ | Pellet |
| | (230° C./3.8 kg, | | | |
| | ASTM D-1238) | | | |
| Epoxy | — | — | — | Liquid (resin and |
| | | | | hardener) |

### Example 4

### Preparation of MDPE Composites

Two filled polymer composites were prepared employing MDPE as the polymer. The first composite was prepared using the OST described in Example 1 as the filler, while the second was prepared using the kaolin clay described in Example 2 as the filler. Both samples were prepared by blending the filler with the MDPE described in Example 3. In each sample, the filler was present in the amount of 20 weight percent based on the total weight of the composite. The blending was performed at ambient temperature. After blending, 0.5 grams of each mixture were placed in separate 13 mm dies, which in turn were placed in an oven and heated for approximately one hour at 130° C. After being removed from the oven, the dies were immediately placed in presses where approximately 10,000 p.s.i. of pressure was applied to the samples for a period of two hours. Each of the resulting samples had a 13 mm diameter and was approximately 2˜3 mm thick.

### Example 5

### Preparation of Nylon 6,6 Composites

Two filled polymer composites were prepared employing nylon 6,6 as the polymer. The first composite was prepared using the OST described in Example 1 as the filler, while the second was prepared using the kaolin clay described in Example 2 as the filler. Due to nylon's high processing temperature (i.e., nylon 6,6 has a melting point of 260° C.), the samples could not be prepared using the die/press method described in Example 4. Instead, the two samples were prepared by heating pellets of nylon 6,6 in a pan with a hot plate and pressing the softened pellets in the respective filler powders to embed the fillers in the pellets. Due to the limitations of this method, an accurate estimate of the weight percent of the filler in each of the samples could not be calculated. However, each of the samples was prepared in substantially the same manner to help ensure approximate equality of filler content.

### Example 6

### Preparation of ABS Composites

Two filled polymer composites were prepared employing ABS copolymer. The first composite was prepared using the OST described in Example 1 as the filler, while the second was prepared using the bentonite clay described in Example 2 as the filler. Both samples were prepared by blending the filler with the ABS described in Example 3. In each sample, the filler was present in the amount of 20 weight percent based on the total weight of the composite. The blending was performed at ambient temperature. After blending, 0.5 grams of each mixture were placed in separate 13 mm dies, which in turn were placed in an oven and heated for approximately one hour. The OST-filled sample was heated at a temperature of 250° C. The bentonite-filled sample, however, could not achieve reasonable fluidity at this temperature, thus producing a sample of such low quality as to be unusable. Accordingly, another bentonite-filled ABS sample was prepared in the same manner and heated in a die at a temperature of 300° C. After being removed from the oven, the dies were immediately placed in presses where approximately 10,000 p.s.i. of pressure was applied to the samples for a period of two hours. Each of the resulting samples had a 13 mm diameter and was approximately 2˜3 mm thick.

### Example 7

### Preparation of Polystyrene Composites

Two filled polymer composites were prepared employing polystyrene as the polymer. The first composite was prepared using the OST described in Example 1 as the filler, while the second was prepared using the kaolin clay described in Example 2 as the filler. Both samples were prepared by blending the filler with the polystyrene described in Example 3. In each sample, the filler was present in the amount of 20 weight percent based on the total weight of the composite. The blending was performed at ambient temperature. After blending, 0.5 grams of each mixture were placed in separate 13 mm dies, which in turn were placed in an oven and heated for approximately one hour at 220° C. After being removed from the oven, the dies were immediately placed in presses where approximately 10,000 p.s.i. of pressure was applied to the samples for a period of two hours. Each of the resulting samples had a 13 mm diameter and was approximately 2˜3 mm thick.

### Example 8

### Preparation of Epoxy Composites

Two filled polymer composites were prepared employing epoxy and hardener. The first composite was prepared using the OST described in Example 1 as the filler, while the second was prepared using the kaolin clay described in Example 2 as the filler. Both samples were prepared by blending the filler with the epoxy and hardener described in Example 3. In each sample, the filler was present in the amount of 5 weight percent based on the total weight of the composite. Additionally, the epoxy and hardener were present in each sample in a 5:1 weight ratio of epoxy-to-hardener. Each sample was stored overnight at ambient temperature and pressure.

### Example 9

### Moisture Resistance Analyses

Moisture resistance analyses were conducted to compare the performance of the OST-filled polymer composites versus the conventional clay-filled polymer composites from Examples 4, 5, and 6 above. The procedures and results of each analysis are described in turn below.

### MDPE Composites

In order to compare the performance of the two MDPE composites prepared in Example 4, a sample of each was boiled in water for one hour. The two samples were then compared by microscopy for differences in appearance. Additionally, each of the samples was weighed before and after boiling to compare their respective resistances to moisture uptake.

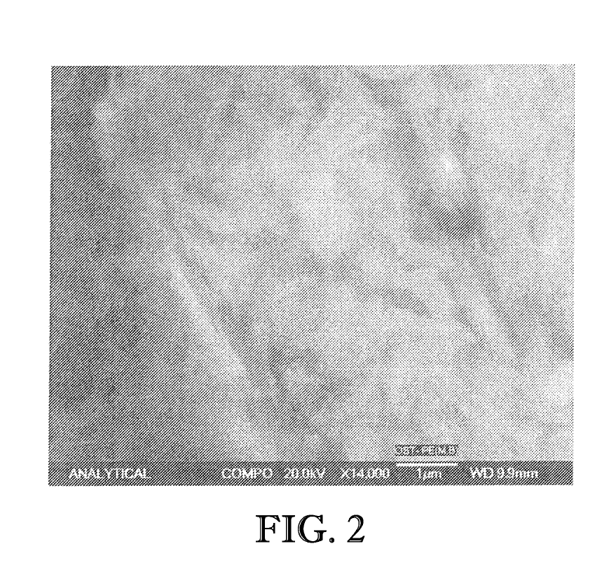

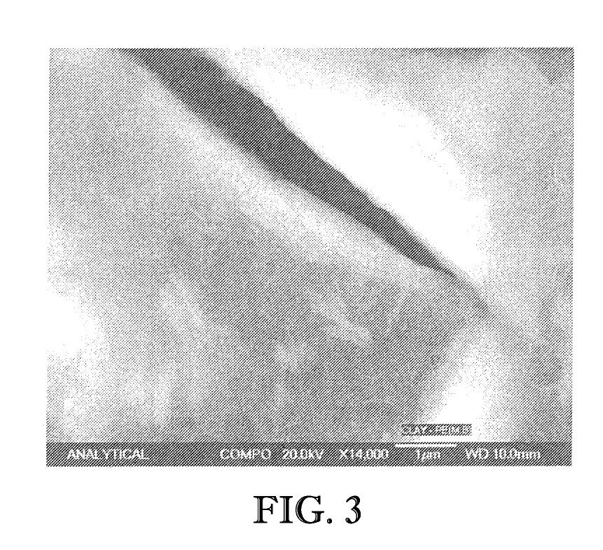

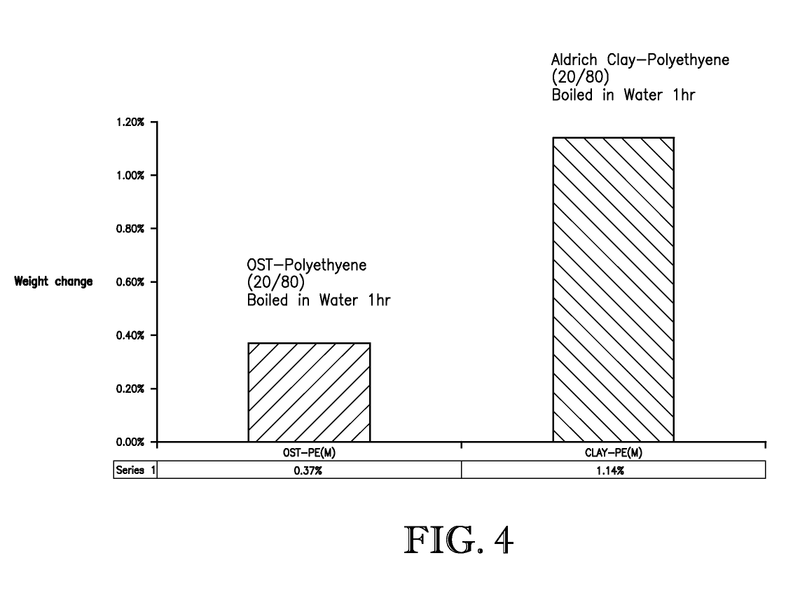

FIGS. 2 and 3 depict the results of the microscopic analysis of the samples prepared in Example 4. FIG. 2 is a microscopic view of the OST-filled MDPE, magnified 14,000 times. FIG. 3 is a microscopic view of the kaolin-filled MDPE, also magnified 14,000 times. FIG. 2 shows a seamless interface of the OST filler with MDPE, even after being boiled for one hour. The kaolin-filled MDPE in FIG. 3, however, shows cracks in the composite, indicating a lower moisture resistance. Additionally, FIG. 4 shows that the OST-filled MDPE had a weight gain after boiling of only 0.37 percent, whereas the kaolin-filled MDPE had a weight gain of 1.14 percent, thus further evidencing the OST-filled MDPE's superior resistance to moisture.

### Nylon 6,6 Composites

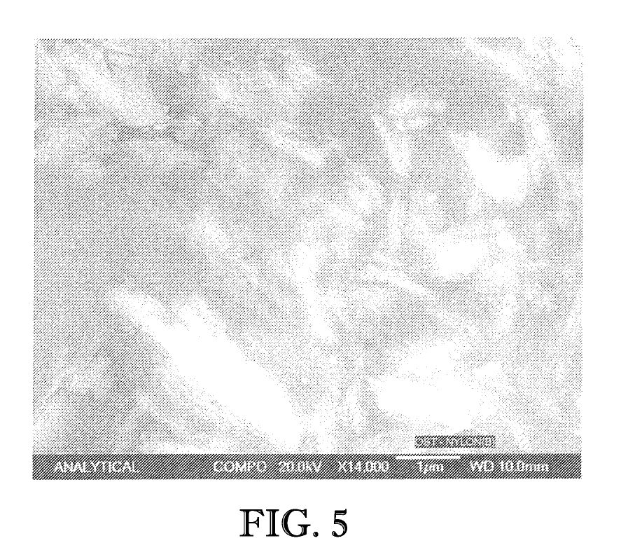

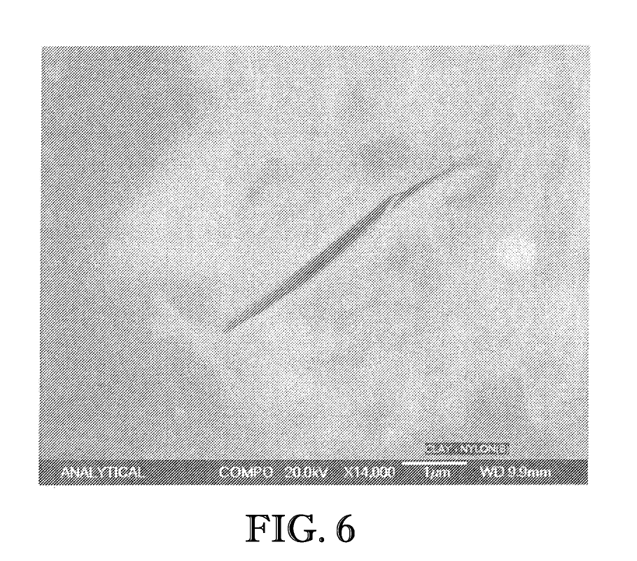

To compare the performance of the nylon 6,6 composites prepared in Example 5, a sample of each was boiled in water for one hour. The two samples were then compared by microscopy for differences in appearance. FIGS. 5 and 6 depict the results of the microscopic analysis. FIG. 5 is a microscopic view of the OST-filled nylon 6,6, magnified 14,000 times. FIG. 6 is a microscopic view of the kaolin-filled nylon 6,6, also magnified 14,000 times. FIG. 5 shows that the OST-filled nylon 6,6 remained intact, even after boiling for one hour. The kaolin-filled nylon 6,6 in FIG. 6, however, shows cracks in the composite, indicating a lower moisture resistance.

### ABS Composites

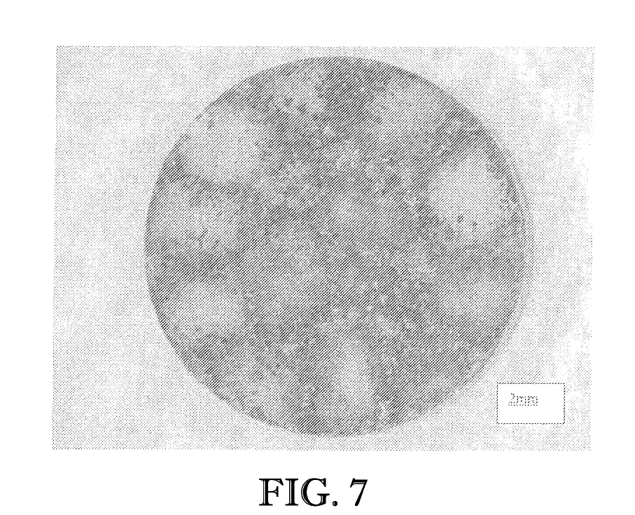

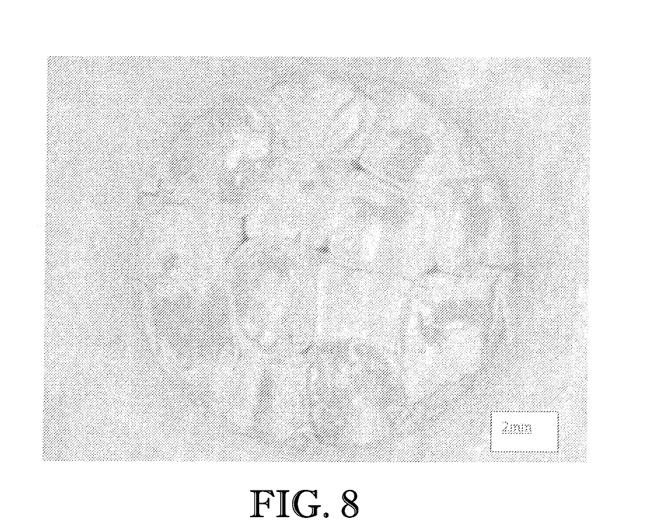

To compare the performance of the ABS composites prepared in Example 6, a sample of each was immersed in ambient temperature water overnight. The two samples were then compared by microscopy for differences in appearance. FIGS. 7 and 8 depict the results of the microscopic analysis. FIG. 7 is a microscopic view of the OST-filled ABS, and FIG. 8 is a microscopic view of the bentonite-filled ABS. FIG. 7 indicates that the OST-filled ABS remained unchanged after being immersed in water, retaining its smooth surface. FIG. 8 indicates that the bentonite-filled ABS, however, lost much of its filler, and its surface became rough and looked chipped. These changes in visual appearance indicate that the bentonite-filled ABS has a lower resistance to moisture than the OST-filled ABS.

### Example 10

### Composite Quality Analysis

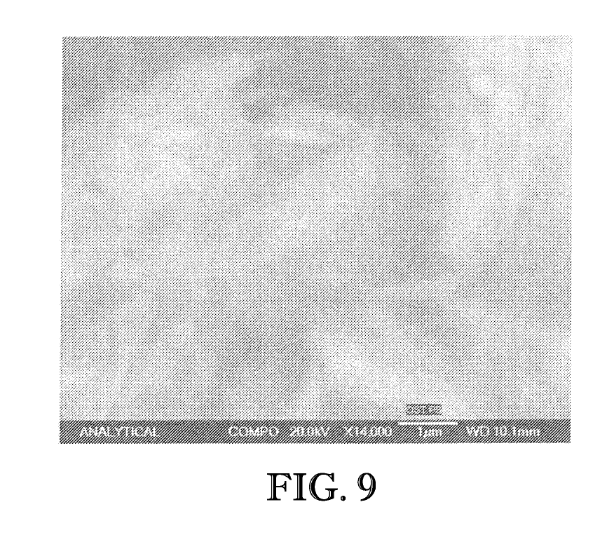

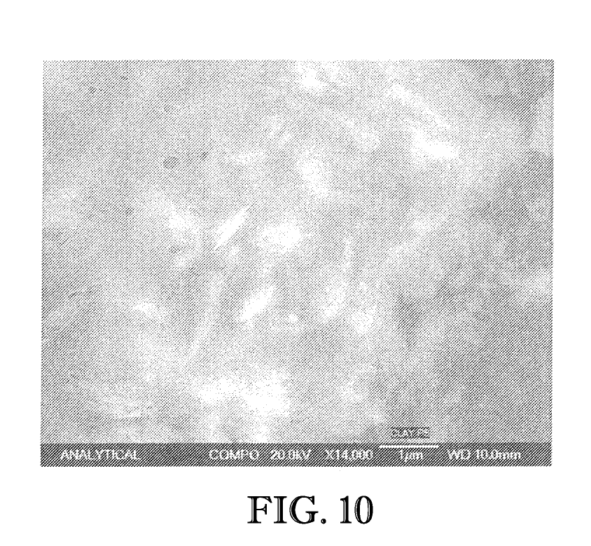

The two polystyrene composites prepared in Example 7 above were compared by microscopy for differences in appearance. FIGS. 9 and 10 depict the results of the microscopic analysis. FIG. 9 is a microscopic view of the OST-filled polystyrene, magnified 14,000 times. FIG. 10 is a microscopic view of the kaolin-filled polystyrene, also magnified 14,000 times. As can be seen by comparing FIGS. 9 and 10, the OST filler produced a higher quality composite with polystyrene than did the kaolin filler, as evidenced by the absence of significant blemishes on the sample surface.

### Example 11

### Thermal Stability Analysis

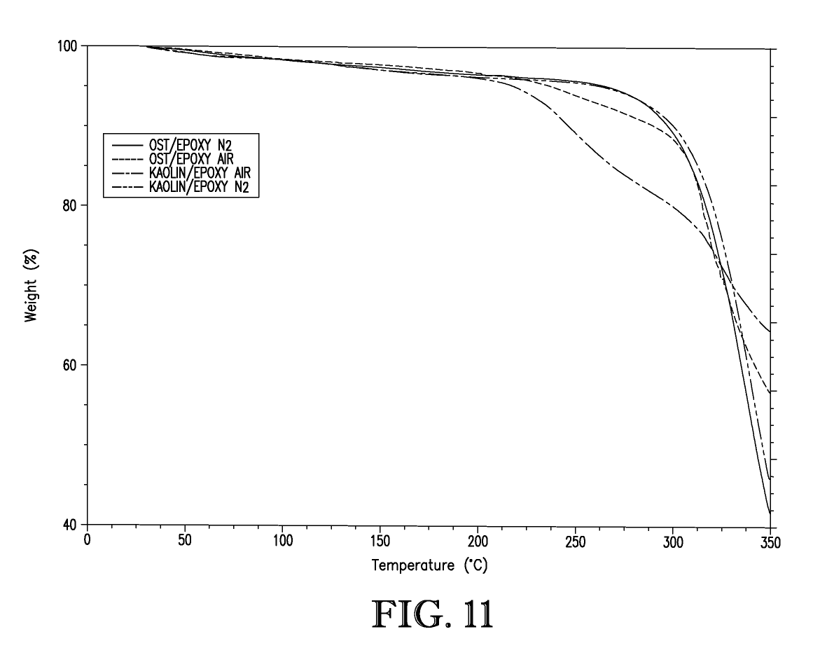

Four samples of the two epoxy composites prepared in Example 8 were compared for thermal stability by thermogravimetric analysis (TGA). One sample of each composite was analyzed for thermal stability by TGA in an air environment, and one sample of each composite was analyzed for thermal stability by TGA in a nitrogen environment. The analyses were performed on a 951 Thermogravimetric Analyzer, available from DuPont Instruments. Each sample was placed on the balance and heated at a substantially constant rate while measuring the weight change. The results from the analyses are illustrated in FIG. 11.

As can be seen by looking at FIG. 11, both the OST-filled epoxy and the kaolin-filled epoxy began to lose weight around 200° C. in the air environment. However, the rate of weight loss for the OST-filled epoxy was significantly less than the rate of weight loss for the kaolin-filled epoxy. In the nitrogen environment, however, the two different composites showed little difference in the temperature range investigated. While not wishing to be bound by theory, it is believed that the OST-filled epoxy's superior performance in air is due to a higher resistance to oxidation. Accordingly, it is apparent that the OST-filled epoxy provides better thermal stability than the kaolin-filled epoxy, at least in an oxygen-containing environment.

### Numerical Ranges

The present description uses numerical ranges to quantify certain parameters relating to the invention. It should be understood that when numerical ranges are provided, such ranges are to be construed as providing literal support for claim limitations that only recite the lower value of the range as well as claims limitation that only recite the upper value of the range. For example, a disclosed numerical range of 10 to 100 provides literal support for a claim reciting “greater than 10” (with no upper bounds) and a claim reciting “less than 100” (with no lower bounds).

### Definitions

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “including,” “includes,” and “include” have the same open-ended meaning as “comprising,” “comprises,” and “comprise.”

As used herein, the terms “having,” “has,” and “have” have the same open-ended meaning as “comprising,” “comprises,” and “comprise.”

As used herein, the terms “containing,” “contains,” and “contain” have the same open-ended meaning as “comprising,” “comprises,” and “comprise.”

As used herein, the terms “a,” “an,” “the,” and “said” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The preferred forms of the invention described above are to be used as illustration only, and should not be used in a limiting sense to interpret the scope of the present invention. Obvious modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. A flame retardant composition comprising at least one polymeric material and at least one filler, wherein at least a portion of said filler comprises a plurality of particles from oil sand tailings.

2. The composition of claim 1, wherein said composition has a limiting oxygen index (LOI) value of at least about 27.

3. The composition of claim 1, wherein said composition has a softening point of at least about 70° C.

4. The composition of claim 1, wherein said composition comprises said filler in an amount of at least about 1 weight percent based on the combined weight of the polymeric material and filler.

5. The composition of claim 1, wherein said composition comprises a weight ratio of said filler to said polymeric material in the range of from about 1:30 to about 9:1.

6. The composition of claim 1, wherein at least about 50 weight percent of said particles comprise fine tails of oil sand tailings.

7. The composition of claim 1, wherein at least a portion of said particles comprise clay.

8. The composition of claim 1, wherein at least a portion of said particles comprise one or more silicates.

9. The composition of claim 8, wherein said silicates comprise an aluminum silicate and/or silicon dioxide.

10. The composition of claim 1, wherein said particles have a median particle size in the range of from about 1 to about 20 micrometers.

11. The composition of claim 1, wherein at least 90 percent of said particles have a particle size of less than about 25 micrometers.

12. The composition of claim 1, wherein said particles have a surface area in the range of from about 1 to about 40 m²/g.

13. The composition of claim 1, wherein said particles are at least partially coated with a hydrocarbonaceous material.

14. The composition of claim 13, wherein said particles comprise said hydrocarbonaceous material in an amount of at least about 0.1 weight percent.

15. The composition of claim 13, wherein said hydrocarbonaceous material comprises hydrocarbon-containing molecules having an average number of carbon atoms of at least about 50.

16. The composition of claim 13, wherein said hydrocarbonaceous material comprises bitumen.

17. The composition of claim 13, wherein said hydrocarbonaceous coating has an average thickness on said particles of at least about 0.5 nm.

18. The composition of claim 1, wherein said filler comprises said particles in an amount of at least about 75 weight percent based on the entire weight of the filler.

19. The composition of claim 1, wherein said polymeric material comprises a thermoplastic, a thermoset, and/or an elastomer.

20. The composition of claim 1, wherein said polymeric material is one or more polymers selected from the group consisting of polyethylene; polystyrene; polyvinyl chloride; nylon 6,6; acrylonitrile-butadiene-styrene copolymer; epoxy resin; polybutadiene; polypropylene; polyurethane; natural rubber; and/or synthetic rubber.

21. The composition of claim 1, further comprising a plastic, fiber, and/or paint formed from said polymeric material and said filler.

22. The composition of claim 1, wherein said oil sand tailings are a byproduct of the extraction of bitumen from oil sands.

23. A method for preparing a flame retardant composition, said method comprising:
(a) blending a polymeric material and a filler to thereby form a mixture; and
(b) heating at least a portion of said mixture, wherein at least a portion of said filler comprises a plurality of particles from oil sand tailings.

24. The method of claim 23, wherein said composition has a limiting oxygen index (LOI) value of at least about 27.

25. The method of claim 23, wherein said composition has a softening point of at least about 70° C.

26. The method of claim 23, wherein said composition comprises a weight ratio of said filler to said polymeric material in the range of from about 1:30 to about 9:1.

27. The method of claim 23, wherein at least about 50 weight percent of said particles comprise fine tails of oil sand tailings.

28. The method of claim 23, wherein at least a portion of said particles comprise clay, wherein at least a portion of said particles comprise one or more silicates.

29. The method of claim 23, wherein said particles are at least partially coated with a hydrocarbonaceous material.

30. The method of claim 29, wherein said particles comprise said hydrocarbonaceous material in an amount of at least about 0.1 weight percent, wherein said hydrocarbonaceous material comprises bitumen.

31. The method of claim 23, further comprising, prior to step (a), drying at least a portion of said filler.

32. The method of claim 23, wherein said mixture is heated to a temperature of at least about 100° C. in said heating of step (b), wherein said heating of step (b) is maintained for at least about 15 minutes.

33. The method of claim 23, wherein said heating of step (b) comprises introducing said mixture into a die and heating said die.

34. The method of claim 33, further comprising (c) applying pressure to at least a portion of said mixture, wherein said applying pressure of step (c) comprises placing said die into a press and applying pressure to said die.

35. The method of claim 34, wherein the pressure applied to said mixture is at least about 300 p.s.i., wherein said pressure of step (c) is maintained for at least about 1 hour.

36. The method of claim 23, wherein said blending of step (a) and said heating of step (b) are performed substantially simultaneously.

37. The method of claim 23, wherein said polymeric material is one or more polymers selected from the group consisting of polyethylene; polystyrene; polyvinyl chloride; nylon 6,6; acrylonitrile-butadiene-styrene copolymer; epoxy resin; polybutadiene; polypropylene; polyurethane; natural rubber; and/or synthetic rubber.

38. A method for preparing a flame retardant composition, said method comprising:
(a) extracting a hydrocarbon-containing material from an oil sand deposit;
(b) processing said hydrocarbon-containing material to thereby produce a separated bituminous material and oil sand tailings, wherein said oil sand tailings comprise a plurality of particles; and
(c) combining at least a portion of said particles with at least one polymeric material to thereby form said flame retardant composition.

39. The method of claim 38, wherein said composition has a limiting oxygen index (LOI) value of at least about 27.

40. The method of claim 38, wherein said composition has a softening point of at least about 70° C.

41. The method of claim 38, step (c) further comprising heating at least a portion of said combined polymeric material and particles to thereby form said flame retardant composition, wherein said combined polymeric material and particles are heated to a temperature of at least about 100° C. in said heating of step (c).

42. The method of claim 38, step (c) further comprising applying pressure to at least a portion of said combined polymeric material and particles to thereby form said flame retardant composition, wherein the pressure applied to said mixture is at least about 300 p.s.i. in step (c).

43. The method of claim 38, further comprising employing said composition as a component in plastic, fiber, and/or paint.

44. The method of claim 38, wherein said composition comprises a weight ratio of said particles to said polymeric material in the range of from about 1:30 to about 9:1.

45. The method of claim 38, wherein at least about 50 weight percent of said particles employed in step (c) comprise fine tails of said oil sand tailings.

46. The method of claim 38, wherein at least a portion of said particles employed in step (c) comprise clay, wherein at least a portion of said particles employed in step (c) comprise one or more silicates.

47. The method of claim 38, wherein said particles employed in step (c) are at least partially coated with a hydrocarbonaceous material.

48. The method of claim 47, wherein said particles employed in step (c) comprise said hydrocarbonaceous material in an amount of at least about 0.1 weight percent.

49. The method of claim 47, wherein said hydrocarbonaceous material comprises bitumen.

50. The method of claim 38, wherein said polymeric material is one or more polymers selected from the group consisting of polyethylene; polystyrene; polyvinyl chloride; nylon 6,6; acrylonitrile-butadiene-styrene copolymer; epoxy resin; polybutadiene; polypropylene; polyurethane; natural rubber; and/or synthetic rubber.
